(19) United States
(12) Patent Application Publication
(10) Pub. No.: US 2015/0227993 A1
(43) Pub. Date: Aug. 13, 2015

(54) IN-NETWORK BARGAIN SHOPPING PLATFORM

(71) Applicants: Beth D. Mix, Fort Mill, SC (US); Edward S. Jenkins, JR., Conyers, GA (US)

(72) Inventors: Beth D. Mix, Fort Mill, SC (US); Edward S. Jenkins, JR., Conyers, GA (US)

(73) Assignee: LOCAL SKINNY INC., Dover, DE (US)

(21) Appl. No.: 14/610,882

(22) Filed: Jan. 30, 2015

Related U.S. Application Data
(60) Provisional application No. 61/937,721, filed on Feb. 10, 2014.

(51) Int. Cl. G06Q 30/06; G06Q 30/02

(52) U.S. Cl. CPC G06Q 30/0601; G06Q 30/0238; G06Q 30/0226

(57) ABSTRACT

Embodiments of the present disclosure may provide a loyalty card with a unique identification code embodied in, for example, a barcode. When swiped or scanned at a point-of-sale location, embodiments may search a database of pricing information to determine a lowest price for a particular item to be purchased. The database of pricing information may include the pricing information for the particular item as aggregated from a plurality of stores. The plurality of stores may be a merchant-members of an exclusive network associated with the loyalty card. In turn, once the lowest in-network price is determined, the platform may enable a charge to be applied to the customer for the lowest price from any of the stores in the network. In yet further embodiments, coupons, discounts, and/or other special offers may be further applied to the price.

### RELATED APPLICATION

Under provisions of 35 U.S.C. §119(e), the Applicants claim the benefit of U.S. provisional application No. 61/937,721, filed on Feb. 10, 2014, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to consumer loyalty programs for commerce and electronic commerce.

### BACKGROUND

It is not uncommon that identical products often have different selling prices at different retail venues. For example, one store may have an item on sale, while other stores are charging full price. Thus, the conventional strategy for bargain shopping is to have the consumer visit multiple stores or search the Internet to find the best price. This often causes problems because the conventional strategy is time-consuming and inefficient for the customer. For example, a consumer might travel to multiple stores in search for the best price, and, in turn, the consumer may still not know if they found the cheapest price.

Moreover, in order for the store to offer a competitive price, the store must expend great effort in finding the market price for each item that it sells or risk losing business if its prices are too high. Many stores have price-matching policies to allow consumers to pay the lowest price if a consumer can present evidence of a lower price. However, this method is time-consuming and may be subject to fraud.

### BRIEF OVERVIEW

Embodiments of the present disclosure may enable consumers to pay the lowest price through methods and systems designed to automatically determine and apply the cheapest price for a given item or items within a network of merchants.

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present disclosure may be enabled to perform the following stages: receiving a unique identifier for a customer; determining, based on the unique identifier, whether the customer is associated with an in-network customer; receiving, in response to a determination that the customer is within the network, a list of items that the customer is purchasing; accessing an in-network merchant database comprising a plurality of items and their corresponding prices; determining the lowest in-network price, based on the in-network merchant database, for each item in the list of items; and offering, to the customer, the lowest in-network price for each item in the list of items.

Embodiments of the present disclosure may be enabled to provide a system configured to: compile of listing of at least one item that a customer desires to purchase, receiving a unique identifier associated with the customer, communicate the unique identifier to a server in operative communication with the system, receiving a sale price for at least one item in the listing, and apply the sale price to the at least one item.

Embodiments of the present disclosure may be enabled to perform the following stages: receiving a merchant identifier; associating the merchant identifier with an in-network merchant; retrieving a listing of items associated with the merchant identifier; retrieving a listing of prices corresponding to the listing of items; storing the listings of items and the list of prices in an in-network merchant database; receiving a request for a lowest price associated with an item; searching the in-network merchant database for the lowest price corresponding to the item; and providing the lowest price.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates an operating environment of a platform consistent with embodiments of the present disclosure;

FIG. 2 illustrates a method for providing in-network bargain shopping;

FIG. 3 illustrates another method for providing in-network bargain shopping; and

FIG. 4 is a block diagram illustrating a computing system capable of providing in-network bargain shopping.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### I. PLATFORM OVERVIEW

Embodiments of the present disclosure may provide a loyalty card with a unique identification code embodied in, for example, a barcode. When swiped or scanned at a retail location, a platform consistent with the embodiments disclosed herein may search a database of pricing information to determine a lowest price for a particular item to be purchased. The database of pricing information may include the pricing information for the particular item as aggregated from a plurality of stores. The plurality of stores may be a merchant-members of an exclusive network associated with the loyalty card. In turn, once the lowest in-network price is determined, the platform may enable a charge to be applied to the customer for the lowest price from any of the stores in the network. In yet further embodiments, coupons, discounts, and/or other special offers (the “discounts”) may be further applied to the price. The discounts may be associated with the exclusive merchant network and, as will be detailed below, stored in a database associated with the merchant network.

Embodiments of the present disclosure may further provide a software application that can be used to scan an item barcode to find the lowest price that the consumer will pay at the store in which he is shopping. The software application may also show a list of stores that have the item available at a lower price in the case where the price is location-specific, for example, at a grand-opening or clearance sale. This function may allow the consumer to decide whether he wants to take advantage of the additional price savings at the cheaper location or purchase the item in the store in which he is currently shopping. In some embodiments, the software application may provide a barcode that may be scanned at the store in which the customer is shopping. The scanning of the barcode may, in turn, act much like a loyalty card in determining and applying the lowest in-network price to the transaction.

### II. PLATFORM CONFIGURATION

An In-Network Shopping platform may be provided. The platform may enable consumers to pay the lowest price through methods and systems designed to automatically determine and apply the cheapest price for a given item or items within a network of merchants. Embodiments of the platform may be used by consumers to take advantage of the lowest price for an item in a given network.

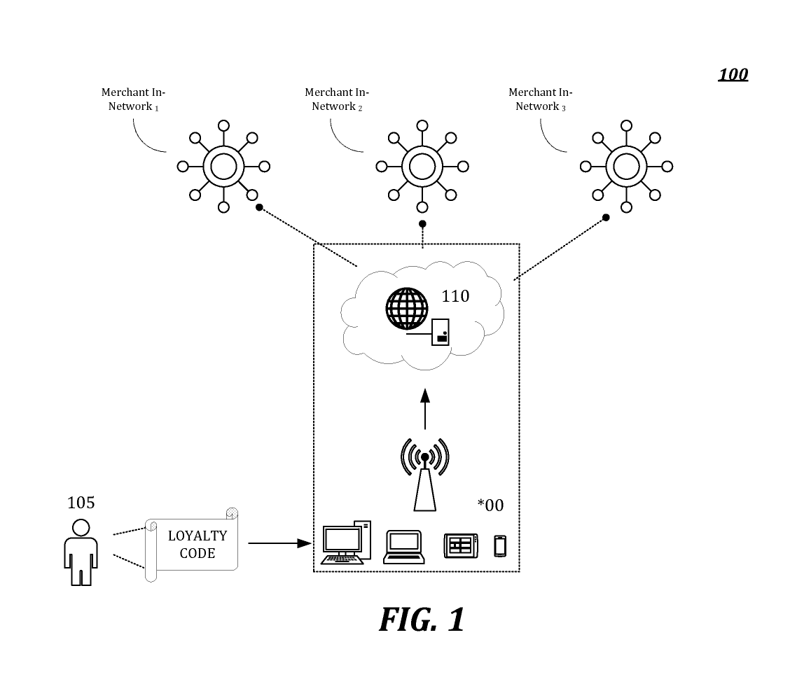

FIG. 1 illustrates one possible operating environment through which a platform consistent with embodiments of the present disclosure may be provided. By way of non-limiting example, platform 100 may be hosted on a centralized server 110, such as, for example, a cloud computing service. A consumer (e.g., user 105) may access platform 100 through, for example, a combination of hardware and software applications. The components may be, for example, integrated with a point-of-sale system (e.g., cash register at a store or a shopping on an electronic commerce website).

For example, a consumer (i.e., platform user 105) may obtain a loyalty card which contains a unique identifier. The unique identifier may comprise, for example, a barcode or magnetic stripe. The consumer may use this card at checkout to scan, swipe or otherwise identify him or herself as the designated customer. In the e-commerce environment, the loyalty card may be replaced with a loyalty code associated with the unique identifier. Computing device 400 may access a database (e.g., in operative communication with server 110) to cross-reference the unique identifier in determining whether the consumer is part of the in-network shopping platform (e.g., affiliated with the loyalty program).

Once the consumer has been identified to be part of the in-network shopping platform, embodiments of the platform may then search an in-network database (e.g., in operative communication with server 110) of prices to find the lowest prices associated with the consumers desired purchases. Once the lowest in-network price is determined, platform may then be enabled to communicate the pricing info back to the point-of-sale system. In turn, the point-of-sale system may charge the user for the lowest price or inform the consumer where a lower price exists.

Still consistent with embodiments of the present disclosure, platform 100 may provide a software application operatively associated with the in-network database (via server 110). The software application may be embodied as, for example, but not be limited to, a website, a web application, a desktop application, and a mobile application compatible with a computing device 400.

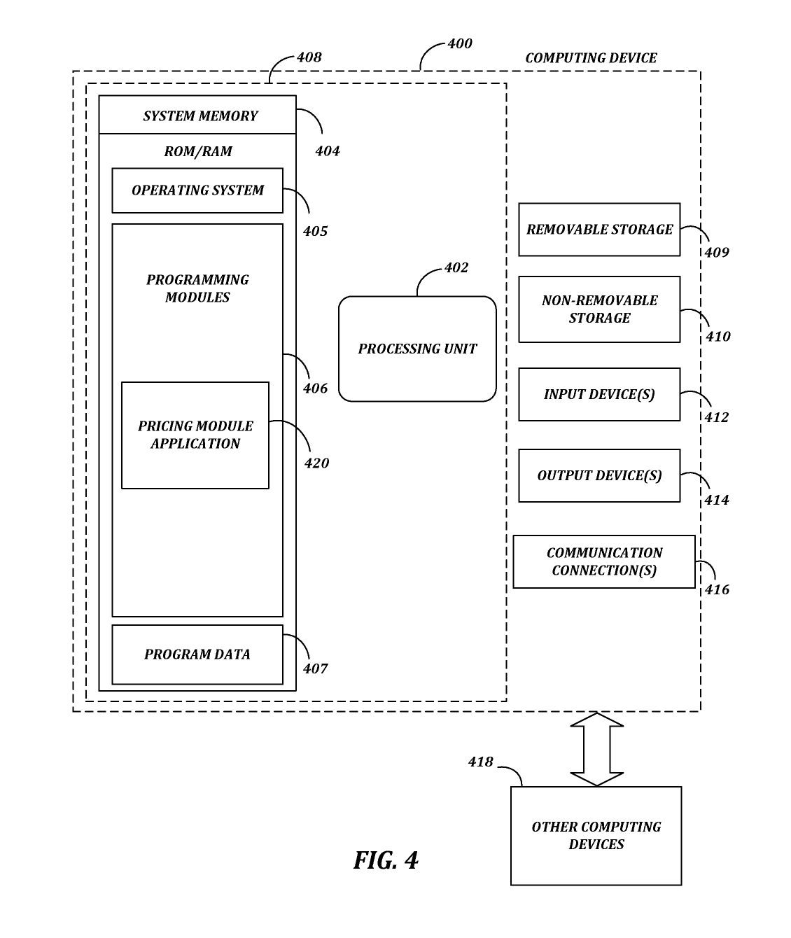

As will be detailed with reference to FIG. 4 below, the computing device through which the platform may be accessed may comprise, but not be limited to, for example, a desktop computer, laptop, a tablet, or mobile telecommunications device. As will be detailed with reference to FIG. 4 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

The consumer may use the software application (the “app”) to scan a barcode or enter an item's corresponding item number. The app may then search the database of the given network of the corresponding store to find the lowest price that the consumer would pay at the present store. The app may also inform the consumer of a lower price within the network that is location-specific, for example, a clearance sale. The consumer may then decide whether he or she wants to pay the higher price at the given store or go to the store with the lower price.

In some embodiments, if the consumer elects to purchase in the store, the app may function as a loyalty card would. For example, the app may display a bar-code that may be scanned upon checkout at a retain location. Moreover, the consumer's unique identifier associated with the bar-code may be used for online shopping. The online-merchant would provide an input field upon checkout for the consumer to enter the unique identifier. In these embodiments, the unique identifier may act much like the loyalty card would, enabling the online-merchant to provide the lowest in-network price to the consumer.

Merchants may apply to join the platform (e.g., loyalty card network). For example, a merchant may provide a host of the loyalty card network with product and price information for the merchant's inventory. The merchant may not be obligated to list the entire inventory, but only a select portion thereof.

As shown in FIG. 1, platform 100 may be configured to host and maintain a plurality of different merchant networks. The platform host may operate a computing system much like the one disclosed in FIG. 4. The computing system may comprise, for example, at least one computing device and a memory storage, accessible via a telecommunications network. The memory storage may comprise a database. The information provided by the merchant may then be parsed and stored in the database corresponding to a particular merchant network for the merchant.

The merchant network may be specified by the merchant, or, in some embodiments, may be determined by, for example, a geographical location of the merchant. In this way, the merchant networks may be formed by merchants electing to be a part of a particular loyalty network. In other embodiments, the merchants may be grouped into network by various factors such as, but not limited to, for example, merchant location and type.

The in-network database may comprise a plurality of prices for the same product, each price corresponding to a different merchant. In this way, the in-network database may easily be searched by, for example, a computing device, in order to derive the lowest price information within a network. The in-network database may be comprised of pricing information associated with a plurality of merchants affiliated with Merchant Networks. The members of the merchant network may access the platform via a merchant/admin portal connected to server 110. The portal may enable the merchant members to provide an updated list of pricing for the products. In other embodiments, existing database infrastructure comprising merchant product pricing may be integrated with server 110. In this way, prices may be automatically updated in platform 100 without manual input.

### III. PLATFORM OPERATION

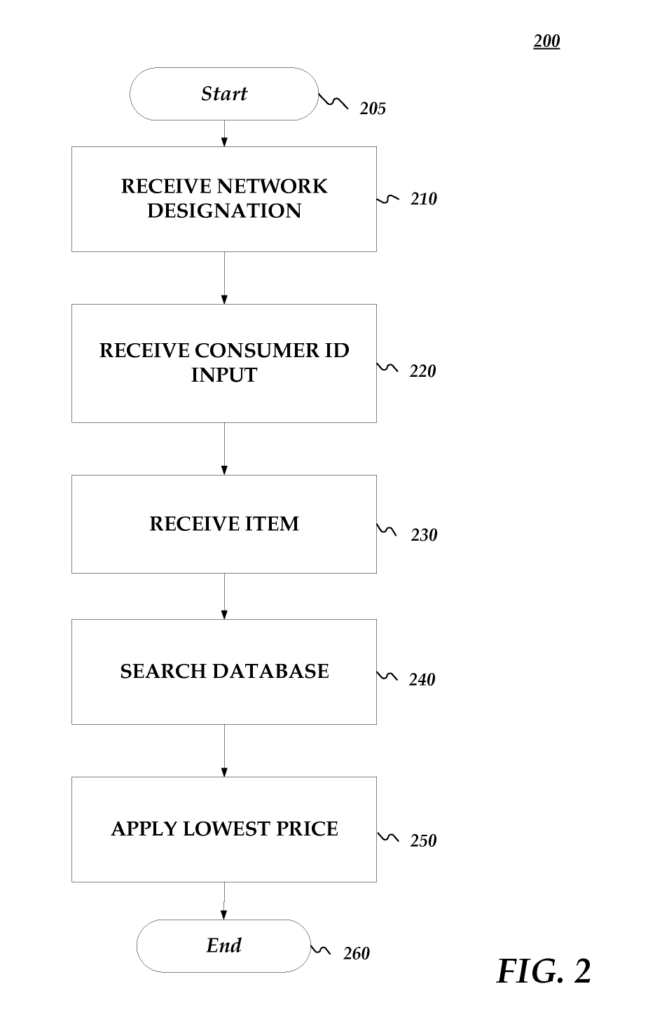

FIG. 2 is a flow chart setting forth the general stages involved in a method 200 consistent with an embodiment of the disclosure for providing platform 100. Method 200 may be implemented using a computing device 400 as described in more detail below with respect to FIG. 4.

Although method 200 has been described to be performed by platform 100, it should be understood that computing device 400 may be used to perform the various stages of method 200. Furthermore, in some embodiments, different operations may be performed by different networked elements in operative communication with computing device 400. For example, server 110 may be employed in the performance of some or all of the stages in method 200. Moreover, server 110 may be configured much like computing device 400.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may begin at Stage 205 and proceed to Stage 210, where a network designation may be received from a merchant. For example, the merchant may designate the network to which it may belong. The designation may be made through a computing platform configured to provide the in-network bargain shopping experience. This network may connect the prices of select inventory to other stores. This network may be specific to a given store, or it may be variable by consumer, for example, a consumer may pay for a premium network that spans to a larger network. The network may be designated, for example, by a distance radius, stores with partnerships, or a plurality of other ways. In some embodiments, this stage may be performed during an initial registration process between the merchant and the platform provider.

From Stage 210, Method 200 may proceed to Stage 220, where consumer identification may be received. In various embodiments, the store may receive this input through, for example, a loyalty card reading. The loyalty card may comprise a unique identifier that may be read by, for example, barcode scanning, magnetic stripe swiping, identification number input or any other method for identifying consumers. The reading may be performed by hardware operatively associated with platform 100. In embodiments where the store is an online merchant, the consumer may be enabled to input his or her identification number upon online-checkout.

From Stage 220, Method 200 may proceed to Stage 230, where the each item that the consumer wishes to purchase may be entered into the platform. For example, at a physical retail store, the items may be entered by, for example, a scanning of a barcode corresponding to the item. Once the barcode is scanned, the barcode information may be communicated to the platform.

From Stage 230, Method 200 may proceed to Stage 240, where the corresponding network's price database may be searched for the lowest price for each item. Consistent with embodiments of this disclosure, the search may be an automated process performed by the computing platform. In other embodiments, the search may be performed manually through the database within the store. Still consistent with embodiments of the disclosure, the platform may also enable a search within a larger merchant-network to show the consumer what he or she could have saved had he been in a network, thereby enticing the consumer to purchase a larger, more premium network.

From Stage 240 where the lowest price may be determined, Method 200 may proceed to Stage 250, where the lowest price may then be apply the particular line-item within consumer's purchase. The platform may also provide information associated with how much the consumer has saved by using the network. From stage 250, Method 200 may proceed to Stage 260 where the method is completed.

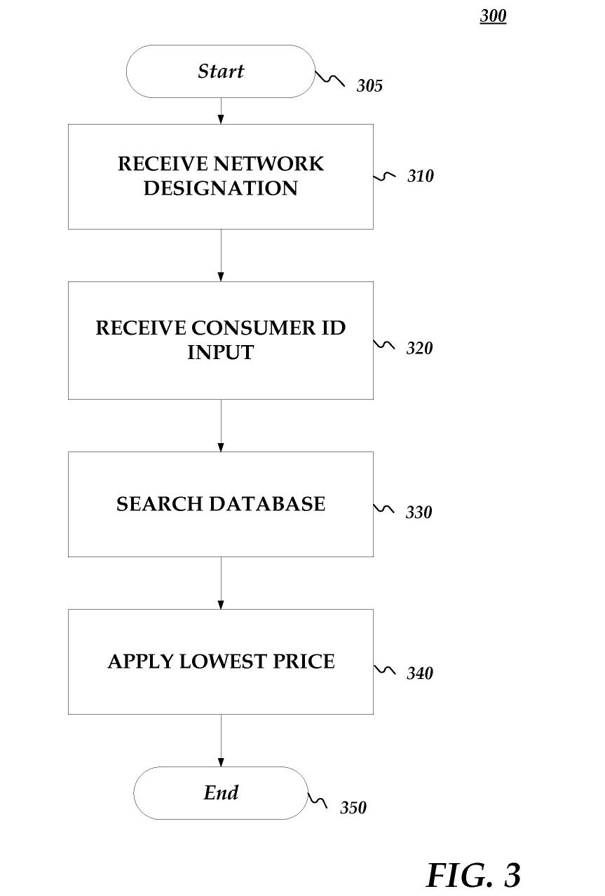

FIG. 3 is a flow chart setting forth the general stages involved in a method 300 consistent with an embodiment of the disclosure for providing platform 100. Method 300 may be implemented using a computing device 400 as described in more detail below with respect to FIG. 4.

Although method 300 has been described to be performed by platform 100, it should be understood that computing device 400 may be used to perform the various stages of method 300. Furthermore, in some embodiments, different operations may be performed by different networked elements in operative communication with computing device 400. For example, server 110 may be employed in the performance of some or all of the stages in method 300. Moreover, server 110 may be configured much like computing device 400.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 300 will be described in greater detail below.

Method 300 may begin at Stage 305 and proceed to Stage 310, where a designation of a merchant network or networks is received. This network may be consistent to all consumers for a given store, or it may be variable by consumer. For example, a consumer may pay for a premium network that spans to a larger network. The network may be designated, for example, by a certain mile radius, stores with partnerships, or a plurality of other ways.

From Stage 310, Method 300 may proceed to Stage 320, where the app determines the consumer network. The app may determine this when the consumer enters his consumer identification information into the app. This may be performed, for example, when the customer types in an identification number. The consumer may also enter the store in which he is shopping in order to designate his network. Also consistent with embodiments of the disclosure, the consumer's location may be determined for example, by global positioning systems (GPS) or cell tower triangulation. This location information may be used to find the network in which he is shopping.

From Stage 320, Method 300 may proceed to Stage 330, where the app receives, through customer input, the item identifier into the app. This may be performed, for example, by allowing the customer to type in the identifying code or scan the item barcode.

From Stage 330, Method 300 may proceed to Stage 340, where the app searches the network database for the lowest price. The app may return the price that the consumer would pay in the given store. The app may also return pricing for the same item within the network that is location specific. This function allows the consumer to determine whether he would like to purchase the item in the given store at a higher price, or whether he would be willing to go to the location of the less-expensive item. If the user determines that he would like to purchase the item in the give store, the customer may be rewarded for his loyalty, for example, by gaining loyalty points. Such loyalty points may reward the consumer in a plurality of ways, for example by giving the consumer cash-back or discounted prices on other items.

From Stage 340, Method 300 may end at Stage 350. Although various stages of Method 300 were disclosed to be performed by an app, it should be understood that any computing system such as, for example, the one disclosed in FIG. 4, may be employed to perform the stages.

### IV. PLATFORM ARCHITECTURE

The platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server (e.g., server 11), such as, for example, a cloud computing service. Although method 200 has been described to be performed by a computing device 400, it should be understood that, in some embodiments, different operations may be performed by different networked elements in operative communication with computing device 400.

At least portions of platform 100 may further be embodied as a point-of-sale system or integrated into an existing point-of-sale system. Moreover, such integrated point-of-sale systems may be in operative communication with server 110. Such integrated point-of-sale systems may comprise a memory storage and a processing unit configured to perform at least portions of the stages of method 200 and 300.

In some embodiments, the processing unit may be configured to perform the following stages: receiving a unique identifier for a customer; determining, based on the unique identifier, whether the customer is associated with an in-network customer; receiving, in response to a determination that the customer is within the network, a list of items that the customer is purchasing; accessing an in-network merchant database comprising a plurality of items and their corresponding prices; determining the lowest in-network price, based on the in-network merchant database, for each item in the list of items; and offering, to the customer, the lowest in-network price for each item in the list of items.

In yet further embodiments, the processing unit may be configured to perform the following stages: compile of listing of at least one item that a customer desires to purchase, receiving a unique identifier associated with the customer, communicate the unique identifier to a server in operative communication with the system, receiving a sale price for at least one item in the listing, and apply the sale price to the at least one item.

Moreover, server 110 may be further associated with a computing device comprising a memory storage and processing unit. The processing unit may be configured to perform the following stages: receiving a merchant identifier; associating the merchant identifier with an in-network merchant; retrieving a listing of items associated with the merchant identifier; retrieving a listing of prices corresponding to the listing of items; storing the listings of items and the list of prices in an in-network merchant database; receiving a request for a lowest price associated with an item; searching the in-network merchant database for the lowest price corresponding to the item; and providing the lowest price.

FIG. 4 is a block diagram of a system including computing device 400. Consistent with an embodiment of the disclosure, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the disclosure.

With reference to FIG. 4, a system consistent with an embodiment of the disclosure may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), nonvolatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include pricing module application 420. Furthermore, embodiments of the disclosure may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g., application 420) may perform processes including, for example, one or more of method 200's and 300's stages as described above. The aforementioned process is an example, and processing unit 402 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

We claim the following:

1. A method comprising:
receiving a unique identifier for a customer;
determining, based on the unique identifier, whether the customer is associated with an in-network customer;
receiving, in response to a determination that the customer is within the network, a list of items that the customer is purchasing;
accessing an in-network merchant database comprising a plurality of items and their corresponding prices;
determining the lowest in-network price, based on the in-network merchant database, for each item in the list of items; and
offering, to the customer, the lowest in-network price for each item in the list of items.

2. The method of claim 1, wherein offering, to the customer, the lowest in-network price for each item comprises applying the lowest in-network price for each item at a point-of-sale.

3. The method of claim 1, wherein receiving the unique identifier comprises receiving the unique identifier at a point-of-sale.

4. The method of claim 3, wherein the unique identifier is received from a reading of at least one of the following: a barcode or a magnetic strip.

5. The method of claim 1, further comprising, offering in-network discounts for at least one of the items in the list of items.

6. The method of claim 1, wherein receiving the list of items comprises receiving the list of items at a point-of-sale.

7. A system comprising:
memory storage; and
a processing coupled to the memory storage, the processing unit being configured to:
compile of listing of at least one item that a customer desires to purchase,
receiving a unique identifier associated with the customer,
communicate the unique identifier to a server in operative communication with the system,
receiving a sale price for at least one item in the listing, and
apply the sale price to the at least one item.

8. The system of claim 7, wherein the memory storage and the processing unit is configured at a point-of-sale.

9. The system of claim 7, wherein the memory storage and the processing unit is integrated with a point-of-sale system.

10. The system of claim 7, wherein the server comprises an in-network merchant database.

11. The system of claim 10, wherein the in-network merchant database comprises a listing of at least one of the following: in-network merchant products, services, and prices associated therewith.

12. A non-transitory computer-readable medium comprising a set of instructions which when executed perform a method comprising:
receiving a merchant identifier;
associating the merchant identifier with an in-network merchant;
retrieving a listing of items associated with the merchant identifier;
retrieving a listing of prices corresponding to the listing of items;
storing the listings of items and the list of prices in an in-network merchant database;
receiving a request for a lowest price associated with an item;
searching the in-network merchant database for the lowest price corresponding to the item; and
providing the lowest price.

13. The non-transitory computer-readable medium of claim 12, wherein retrieving the list of items comprises receiving the list of items from the merchant.

14. The non-transitory computer-readable medium of claim 12, wherein retrieving the list of items comprises accessing a database with the list of items.

15. The non-transitory computer-readable medium of claim 14, further comprising periodically accessing the database to update the listing of prices.

16. The non-transitory computer-readable medium of claim 12, wherein retrieving the list of prices comprises receiving the list of items from the merchant.

17. The non-transitory computer-readable medium of claim 12, wherein retrieving the list of prices comprises accessing a database with the list of items.

18. The non-transitory computer-readable medium of claim 17, further comprising periodically accessing the database to update the listing of prices.

19. The non-transitory computer-readable medium of claim 12, further comprising:
receiving a unique identifier for a customer;
determining, based on the unique identifier, whether the customer is associated with an in-network customer;
receiving, in response to a determination that the customer is within the network, a list of items that the customer is purchasing;
accessing an in-network merchant database comprising a plurality of items and their corresponding prices;
determining the lowest in-network price, based on the in-network merchant database, for each item in the list of items; and
offering, to the customer, the lowest in-network price for each item in the list of items.

20. The non-transitory computer-readable medium of claim 19, wherein offering, to the customer, the lowest in-network price for each item comprises applying the lowest in-network price for each item at a point-of-sale.
